(19) United States
(12) Patent Application Publication
(10) Pub. No.: US 2021/0248462 A1
(43) Pub. Date: Aug. 12, 2021

(54) INTERPRETING CONVOLUTIONAL SEQUENCE MODEL BY LEARNING LOCAL AND RESOLUTION-CONTROLLABLE PROTOTYPES

(71) Applicant: NEC Laboratories America, Inc., Princeton, NJ (US)

(72) Inventors: Jingchao Ni, Princeton, NJ (US); Zhengzhang Chen, Princeton Junction, NJ (US); Wei Cheng, Princeton Junction, NJ (US); Bo Zong, West Windsor, NJ (US); Haifeng Chen, West Windsor, NJ (US)

(21) Appl. No.: 17/158,466

(22) Filed: Jan. 26, 2021

Related U.S. Application Data
(60) Provisional application No. 62/971,276, filed on Feb. 7, 2020.

(51) Int. Cl. G06N 3/08; G06N 3/04

(52) U.S. Cl. CPC G06N 3/08; G06N 3/04

(57) ABSTRACT

A method interprets a convolutional sequence model. The method converts an input data sequence having input segments into output features. The method clusters the input segments into clusters using respective resolution-controllable class prototypes allocated to each of classes. Each respective class prototype includes a respective output feature subset characterizing a respective associated class. The method calculates, using the clusters, similarity scores that indicate a similarity of an output feature to a respective class prototypes responsive to distances between the output feature and the respective class prototypes. The method concatenates the similarity scores to obtain a similarity vector. The method performs a prediction and prediction support operation that provides a value of prediction and an interpretation for the value responsive to the input segments and similarity vector. The interpretation for the value of prediction is provided using only non-negative weights and lacking a weight bias in the fully connected layer.

### RELATED APPLICATION INFORMATION

This application claims priority to U.S. Provisional Patent Application No. 62/971,276, filed on Feb. 7, 2020, incorporated herein by reference entirety.

### BACKGROUND

### Technical Field

The present invention relates to machine learning and more particularly to interpreting a convolutional sequence model by learning local and resolution-controllable prototypes.

### Description of the Related Art

Sequence data is prevalent in a variety of real-life applications, such as the digitized protein sequences in computational biology, Electronic Health Records (EHRs) in healthcare, and the event logs of marketing campaigns in business or of monitored machines in a factory or other manufacturing setting. Recent rapid developments on deep learning have produced many models that can make encouragingly precise decisions on sequence data, such as Long Short-Term Memories (LSTMs), Gated Recurrent Units (GRUs), Convolutional Neural Networks (CNNs), WaveNet and ResNet. However, the commercialization of these models in decision critical domains has been slow compared to its academic progress. One important reason is the lack of interpretability and transparency, which significantly prevents trusts from end users. Even domain experts may have doubts on the model outputs. In many scenarios, only outputting predictions or even predictions plus statistical confidence may not be sufficient. Therefore, “opening the black box” has become a crucial topic for understanding the rationale underlying the predictions in decision critical domains.

### SUMMARY

According to aspects of the present invention, a computer-implemented method is provided for interpreting a convolutional sequence model. The method includes converting, by a convolutional layer having one or more filters and a sliding window, an input data sequence having a plurality of input segments into a set of output features. The method further includes clustering, in multiple protype storage elements, the plurality of input segments into clusters using respective resolution-controllable class prototypes allocated to each of a plurality of classes. Each of the respective resolution-controllable class prototypes includes a respective subset of the output features that characterizes a respective associated one of the plurality of classes, The method also includes calculating, using the clusters, similarity scores that indicate a similarity of a given one of the output features to a given one of the respective resolution-controllable class prototypes responsive to distances, in a latent space, between the output feature and the respective resolution-controllable class prototypes. The method additionally includes concatenating the similarity scores to obtain a similarity vector. The method further includes performing, by a fully connected layer, a prediction and prediction support operation that provides a value of prediction and an interpretation for the value of prediction responsive to the input segments and the similarity vector. The interpretation for the value of prediction is provided using only non-negative weights and lacking a weight bias in the fully connected layer.

According to further aspects of the present invention, a computer program product is provided for interpreting a convolutional sequence model. The computer program product includes a non-transitory computer readable storage medium having program instructions embodied therewith. The program instructions are executable by a computer to cause the computer to perform a method. The method includes converting, by a convolutional layer having one or more filters and a sliding window, an input data sequence having a plurality of input segments into a set of output features. The method further includes clustering, in multiple protype storage elements, the plurality of input segments into clusters using respective resolution-controllable class prototypes allocated to each of a plurality of classes. Each of the respective resolution-controllable class prototypes includes a respective subset of the output features that characterizes a respective associated one of the plurality of classes. The method also includes calculating, using the clusters, similarity scores that indicate a similarity of a given one of the output features to a given one of the respective resolution-controllable class prototypes responsive to distances, in a latent space, between the output feature and the respective resolution-controllable class prototypes. The method additionally includes concatenating the similarity scores to obtain a similarity vector. The method further includes performing, by a fully connected layer, a prediction and prediction support operation that provides a value of prediction and an interpretation for the value of prediction responsive to the input segments and the similarity vector. The interpretation for the value of prediction is provided using only non-negative weights and lacking a weight bias in the fully connected layer.

According to still further aspects of the present invention, a computer processing system is provided for interpreting a convolutional sequence model. The computer processing system includes a memory device for storing program code therein. The computer processing system further includes a processor device operatively coupled to the memory device for running the program code to convert, using a convolutional layer having one or more filters and a sliding window, an input data sequence having a plurality of input segments into a set of output features. The processor device further runs the program code to cluster, in multiple protype storage elements in the memory device, the plurality of input segments into clusters using respective resolution-controllable class prototypes allocated to each of a plurality of classes. Each of the respective resolution-controllable class prototypes includes a respective subset of the output features that characterizes a respective associated one of the plurality of classes. The processor device also runs the program code to calculate, using the clusters, similarity scores that indicate a similarity of a given one of the output features to a given one of the respective resolution-controllable class prototypes responsive to distances, in a latent space, between the output feature and the respective resolution-controllable class prototypes. The processor device additionally runs the program code to concatenate the similarity scores to obtain a similarity vector. The processor device further runs the program code to perform, by a fully connected layer, a prediction and prediction support operation that provides a value of prediction and an interpretation for the value of prediction responsive to the input segments and the similarity vector. The interpretation for the value of prediction is provided using only non-negative weights and lacking a weight bias in the fully connected layer.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing the overall architecture of SCNpro, in accordance with an embodiment of the present invention;

FIG. 3 is a high-level diagram showing an exemplary system/method for model training, in accordance with an embodiment of the present invention;

FIG. 4 is a high-level diagram showing an exemplary system/method for model inference, in accordance with an embodiment of the present invention;

FIG. 5 is a block diagram showing an exemplary computing environment, in accordance with an embodiment of the present invention;

FIG. 6 is a flow diagram showing an exemplary method for interpreting a convolutional sequence model by learning local and resolution-controllable prototypes, in accordance with an embodiment of the present invention.

### DETAILED DESCRIPTION OF PREFERRED EMBODIMENTS

Embodiments of the present invention are directed to interpreting a convolutional sequence model by learning local and resolution-controllable prototypes.

In one or more embodiments of the present invention, a deep sequence model is proposed that interprets its own reasoning process. The trained model naturally comes with explanations for each prediction, and the explanations are loyal to what the network actually computes. In particular, it is proposed to define a form of interpretability in sequence processing that imitates the way that human makes decisions in classification tasks, for example, when a human classifies a sequence, the human might locate several small, interesting segments of the sequence and compare them with exemplar segments of the sequences in given classes.

In one or more embodiments of the present invention, a sequence convolutional network is combined with prototype learning and a new deep learning model referred to as “SCNpro” is proposed to achieve both interpretability and high accuracy for sequence modeling. SCNpro selects from the training set a limited number of prototypical segments that are deterministic in classifying new sequences, and learns an internal notion of similarity for comparing segments of new sequences with those learned prototypes. In this way, SCNpro is interpretable, in the sense that it has a transparent reasoning process that is actually used to make predictions.

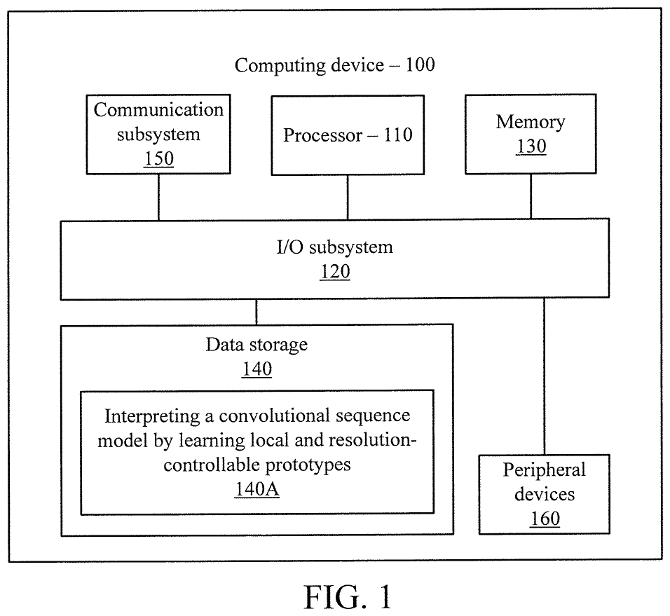

FIG. 1 is a block diagram showing an exemplary computing device 100, in accordance with an embodiment of the present invention.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for interpreting a convolutional sequence model by learning local and resolution-controllable prototypes. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

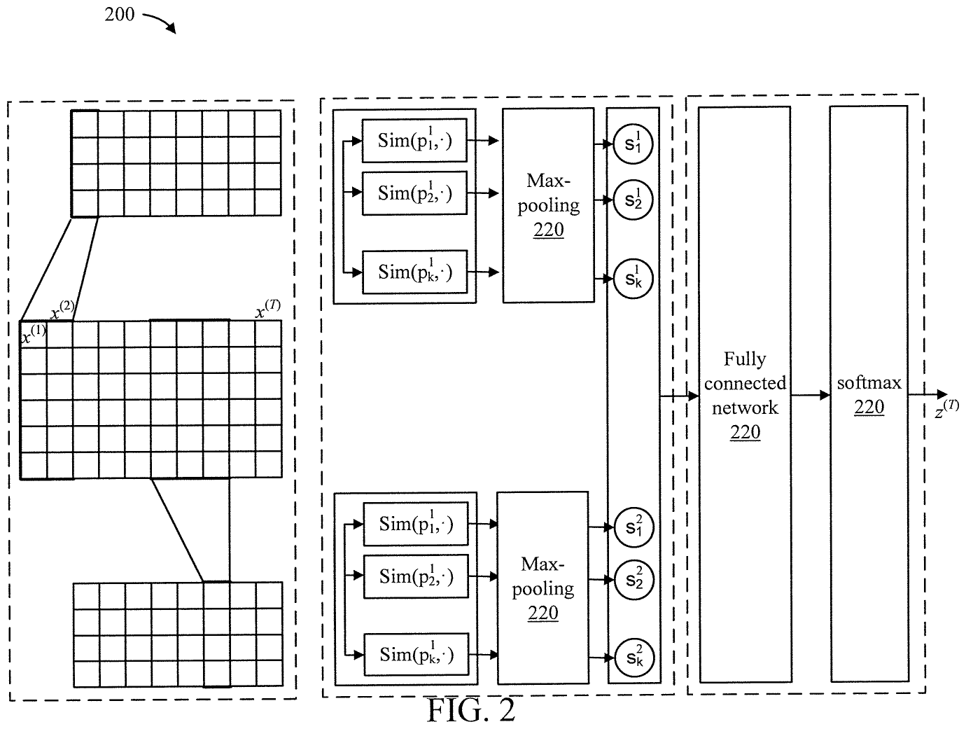

FIG. 2 is a block diagram showing the overall architecture 200 of SCNpro, in accordance with an embodiment of the present invention. In the illustrative embodiment of FIG. 2, there are three major components of the architecture 200 as follows: (1) a convolutional layer 210; (2) a prototype layer 220; and (3) an output layer 230.

The convolutional layer 210 involves one or more filters W with sliding window that receive an input sequence and output a feature. The prototype layer 220 involves multiple protype elements 221, max pooling 222, and resultant similarity scores sᵢ. Each of the prototype elements 221 is associated with a respective filter of the convolutional layer and is allocated a respective cluster of class prototypes. The output layer 230 includes a full connected layer 231 and resultant softmax 232.

In the following, we describe each of the preceding components of SCNpro in further detail.

A further description will now be given regarding the convolutional layer 210, in accordance with an embodiment of the present invention.

Given an input sequence {x^{(t)}}, the convolutional operation involves a filter W with a filter size w. The filter is applied to a window of w time steps to produce a new feature. Specifically, a new feature z^{(t)} is generated from a window [x^{(t)}, . . . , x^{(t+w-1)}] by the following:

z^{(t)}=ƒ(W*[x^{(t)}, . . . ,x^{(t+w-1)}]+b) (1)

where b is a bias, f(.) is a non-linear function, [. , .] represents concatenation, and the * operator provides the sum of an element-wise multiplication.

Equation (1) accomplishes the computation in one output channel. Similar to image processing, multiple channels can be present in one filter. Suppose a filter has h output channels, then a vectorial output z^{(t)} can be achieved as the new feature.

By setting stride as 1, the filter is applied to each possible window of the input sequence to produce a feature map [z⁽¹⁾, . . . , x^{(T-w+1)}]. As can be seen, z^{(t)} is a latent representation that corresponds to the segment starting at time step t and ending at t+w−1.

A conventional convolutional network applies a row-wise max-pooling to extract salient features for downstream tasks. Despite being useful, this operation masks out the individual meaning of z^{(t)}, thus hindering explanation. In contrast, the present invention preserves the feature map, and compares each segment feature z^{(t)} to prototypes in a latent space.

Furthermore, it is beneficial to have multiple filters with different sizes w's so that more fine-grained information can be extracted. In the following, for clarity, the architecture of the present invention is described based on one filter. Extension to multiple filters is straightforward since filters are parallel, as readily appreciated by one of ordinary skill in the art given the teachings of the present invention provided herein.

A further description will now be given regarding the prototype layer 220, in accordance with an embodiment of the present invention.

Suppose there are g filters, the prototype layer includes g elements, each associates with one filter. The reason for designing separate elements is to accommodate the incompatible latent spaces that may be rendered by different filters, e.g., different numbers of output channels.

For a particular element, we allocate k prototypes for each class, so that every class will be represented by some prototypes, and no class will be left out. Let Pᵢ={p^{(j)}}ⱼ₌₁^{k} be the set of prototypes that are allocated to class i, where p^{(j)} has the same dimensionality as the segment feature z^{(t)}. Each prototype vector can be understood as a latent representation for some prototypical segment, which will be learned through gradient descent. Then the entire set of prototypes stored in this element is P=∪Pᵢ, with a cardinality ck.

In the prototype layer 220, each element computes the squared L2 distances between each segment feature of a sequence and each prototype, and converts the distances to similarity scores

s^{(t,j)}=exp(−∥z^{(t)}−p^{(j)}∥₂²)

where the similarity score ranges from 0 to 1. 0 means the segment feature z^{(t)} is completely different from the prototype p^{(j)}, and 1 means they are identical.

For each prototype p^{(j)}, after calculating s^{(1,j)}, . . . , s^{(T-w+1,j)}, for all segment features, a max-pooling is performed to obtain s^{(j)} as follows:

s^{{j}}=max [s^{(1,j)}, . . . ,s^{((T-w+1),j)}]

The intuition is to capture the occurrence of the prototype p^{(j)}. If s^{(j)} is large, then there is a feature in the feature map that is very close to the prototype p^{(j)} in the latent space, and this in turn means there is a segment in the input sequence that has a similar structure to what p^{(j)} represents.

With the computed similarity scores s^{(j)} for all prototypes in all elements, concatenation is performed to concatenate them to shape a similarity vector s, which is then fed to the output layer for target prediction.

A further description will now be given regarding the output layer 230, in accordance with an embodiment of the present invention. The output layer has a fully connected layer that computes a=Ws, where W is the weight matrix, and c is the output size (i.e., the number of classes in the classification tasks). To enable interpretability, a constraint W is added which is non-negative. Lack of bias helps interpretability because the interpretation only concerns how the values in s combine to obtain the values in a. This information can be obtained by looking into the values of W. Including bias will add some uncertainty to the relationship, which is difficult to interpret. Also, non-negative values in W helps intuitive comparison of the strengths of different relationships, and therefore facilitate ranking and selection the most important prototypes based on the strong relationships.

For multi-class classification tasks, a softmax layer is then used to compute the predicted probability

$${\hat{y}}_{i} = exp ( {a}_{i} ) / {\sum }_{j = 1}^{c} exp ( {a}_{j} )$$

where ŷ represents the output, and its i-th entry is ŷᵢ.

A description will now be given regarding the optimization problem, in accordance with an embodiment of the present invention.

The optimization problem reflects the needs for both accuracy and interpretability. For accuracy, cross-entropy loss is used for penalizing the misclassification on the training dataset

[symbol]

ₑ( [symbol] ;θ)=Σ_{({x}_{^{(t)}}_{}}_{ₜ₌₁}_{^{T}}_{,y)∈} [symbol] [symbol] (y)^{T} log(ŷ)+(1 [symbol] (y))^{T} log(1−ŷ) (2)

where θ represents the set of all trainable parameters of the model.

To enhance interpretability, two major criteria, clustering and association, have been proposed to manipulate the prototypes in the latent space. However, existing loss functions that realize these criteria cannot be applied on prototypes that represent segments. Therefore, in accordance with the present invention, new loss functions are described herein to serve the purpose.

A description will now be given regarding clustering, in accordance with an embodiment of the present invention.

As previously discussed, each prototype can be understood as a feature that characterizes its associated class. Every training sequence is supposed to be linked to some prototypes (i.e., has certain features) for determining its label. To this end, during model training, a segment of every encoded sequence is pushed to be as close as possible to at least one of the prototypes by minimizing the following

$${l}_{c} ( 𝒟 ; θ ) = {\sum }_{( [ {x}^{( t )} \{ \begin{matrix}T \\ t = 1\end{matrix} , y ) ∈ D} {min}_{{p}^{(* )} ∈ 𝒫 y} {min}_{1 \leq t \leq ( T - w + 1 )} {‖ {z}^{( t )} - {p}^{(* )} ‖}_{2}^{2} \qquad ( 3 )$$

where P_{y} represents the set of prototypes that are associated with class y, where [symbol] represents the training dataset as follows: [symbol] ={((xᵢ^{(t)})ₜ₋₁^{T},y₁)}ᵢ₌₁ⁿ, where xᵢ^{(t)})ₜ₋₁^{T} is the sequence data of length T, and y is the label. Recall that every class has been allocated prototypes.

The above Equation (3) encourages a cluster around each prototype so that each prototype is representative, which facilitates the L2 distance based classification in accordance with the present invention. It is to be appreciated that a segment is only pushed toward a prototype of its own class. This constraint circumvents the scenario when samples of mixed classes are clustered together.

A description will now be given regarding association, in accordance with an embodiment of the present invention.

For interpretation, each prototype should be mapped to a certain real segment so that it can be given a practical meaning. To achieve this via gradient descent, a loss function is added to encourage each prototype to be as close as possible to a certain segment in the training domain by the following

$${ℓ}_{a} ( 𝒟 ; θ ) = {\sum }_{i = 1}^{C} {\sum }_{{p}^{( * )} ∈ {P}_{i}} {min}_{{z}^{( * )} ∈ {𝒵}_{i}} {‖ {p}^{( * )} - {z}^{( * )} ‖}_{2}^{2} \qquad ( 4 )$$

where Zᵢ represents the set of all segment features that are generated by the set of sequences with label y=i. Similar to Equation (3), in Equation (4), a prototype is only pushed toward a segment of its own class.

A description will now be given regarding diversity, in accordance with an embodiment of the present invention.

It has been found that similar or even duplicate prototypes may be generated by model training. Using multiple similar prototypes for explanation could be confusing, meanwhile they also reduce the effective use of model parameters. To circumvent this phenomenon, a diversity regularization is used that penalizes small distances between prototypes as follows

[symbol]

_{d}(θ)=Σᵢ₌₁^{ck}Σⱼ₌₁₊₁^{ck} max(0,dₘᵢₙ−∥p⁽ⁱ⁾−p^{(j)}∥₂²) (5)

where dₘᵢₙ is a threshold that determines whether two prototypes are close or not. Equation (5) takes all prototypes in each element into account, no matter what classes they belong to.

A description will now be given regarding an objective function, in accordance with an embodiment of the present invention.

Now, the cross-entropy in Equation (2) and the aforementioned three criteria in Equation (3), Equation (4), and Equation (5) can be integrated into a unified loss function as follows

[symbol]

( [symbol] ;θ)= [symbol] ₑ( [symbol] ;θ)+Σᵢ₌₁^{g}(λ_{c} [symbol] _{c}( [symbol] ;θ)+λₐ [symbol] ₐ( [symbol] ;θ)+λ_{d} [symbol] _{d}(θ)) (6)

where the three criteria are summed over all g filters, and λ_{c}, λₐ, λ_{d} are trade-off parameters, which are selected according to validation datasets in experiments.

A description will now be given regarding a training algorithm, in accordance with an embodiment of the present invention.

To train the SCNpro model, stochastic gradient descent (SDG) with mini-batch can be employed to minimize the loss function in Equation (6) using the training dataset. After this training stage is complete, every prototype p is close to a certain segment in the training data due to the loss in Equation (4). However, p is a representation in latent space, thus is not readily interpretable. To visualize the prototypes as training segments, each prototype is projected (“pushed”) onto the latent representation of its closest segment neighbor, which fills the last gaps remained by gradient descent as follows:

$${P}^{(* )} ← arg {min}_{{z}^{( * )} ∈ {𝒵}_{i}} {‖ {p}^{(* )} - {z}^{(* )} ‖}_{2}^{2} , ∀ {p}^{(* )} ∈ {𝒫}_{i}$$

where Zᵢ and Pᵢ are the sets of all segment features and prototypes of class i, respectively. This means prototypes are only projected to segments of its own classes.

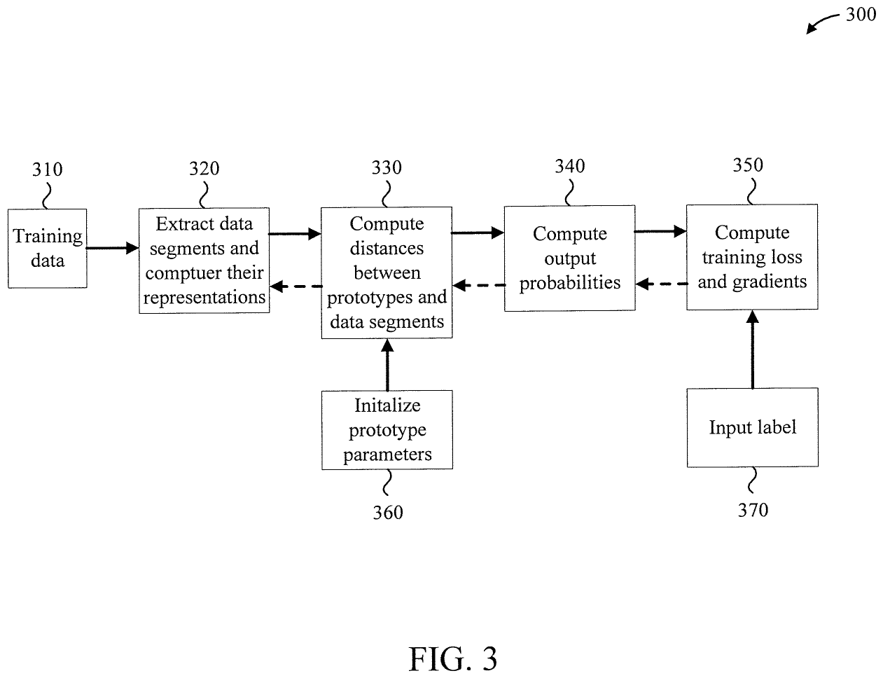

FIG. 3 is a high-level diagram showing an exemplary system/method 300 for model training, in accordance with an embodiment of the present invention.

In FIG. 3, a sold-lined arrow indicates a forward propagation direction, and a dashed arrow indicates a backward propagation direction.

At block 310, receive training data from a training database 391.

At block 320, extract, by the convolutional layer 210, data segments and compute their representations.

At block 330, compute, by the prototype layer 220, distances between prototypes and data segments.

In an embodiment, block 330 can include block 330A.

At block 330A, initialize prototype parameters.

At block 340, compute, by the output layer 230, output probabilities.

At block 350, computing training loss and gradients.

In an embodiment, block 350 can include block 350A.

At block 350A, input a label(s).

At blocks, 350, 340, 330, and 320, perform backpropagation using gradient descent.

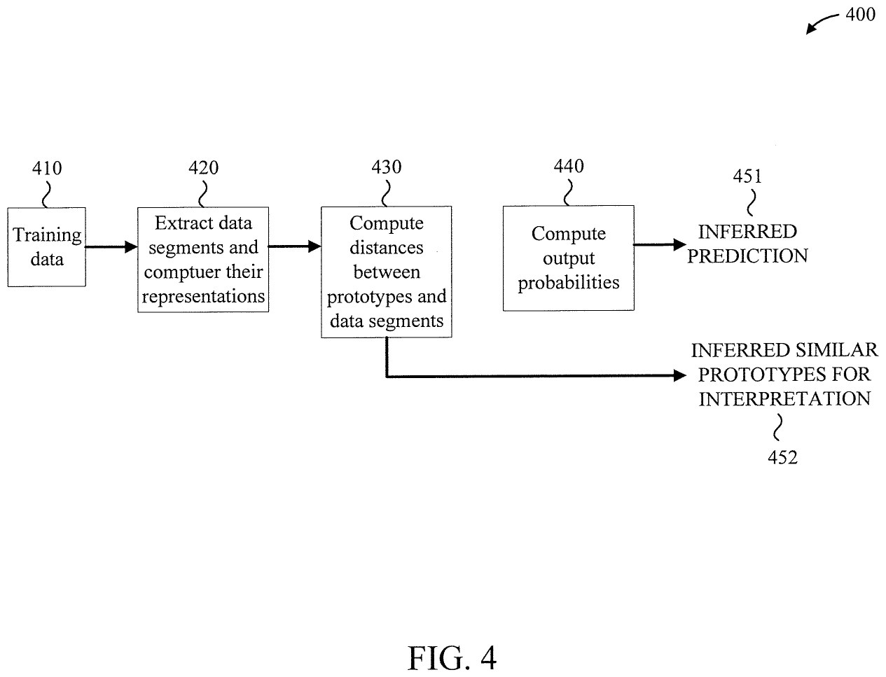

FIG. 4 is a high-level diagram showing an exemplary system/method 400 for model inference, in accordance with an embodiment of the present invention.

At block 410, receive training data from a testing database 491.

At block 420, extract, by the convolutional layer 210, data segments and compute their representations.

At block 430, compute, by the prototype layer 220, distances between prototypes and data segments.

At block 440, compute, by the output layer 230, output probabilities.

The output layer 230 outputs an inferred prediction 451 and the prototype layer 220 outputs inferred similar prototypes 452 for interpretation.

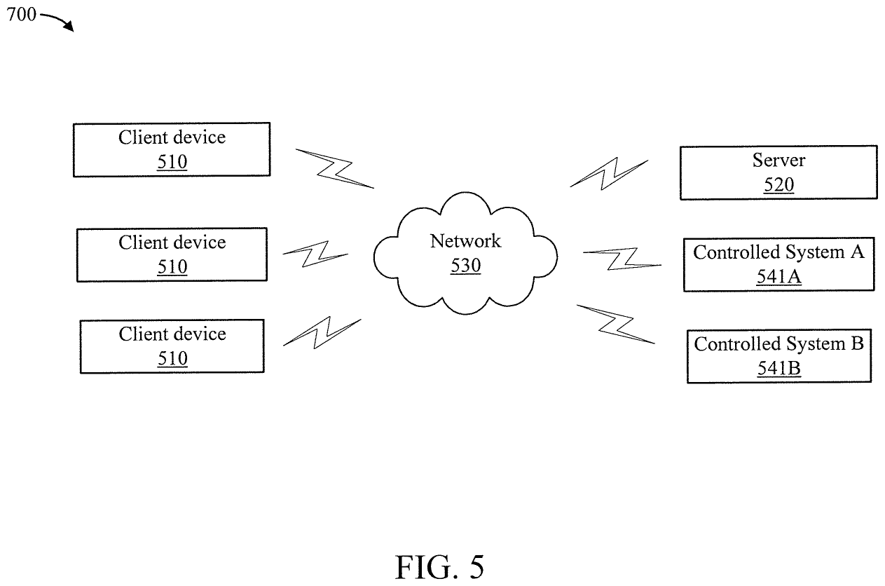

FIG. 5 is a block diagram showing an exemplary computing environment 500, in accordance with an embodiment of the present invention.

The environment 500 includes a server 510, multiple client devices (collectively denoted by the figure reference numeral 520), a controlled system A 541, and a controlled system B 542.

Communication between the entities of environment 500 can be performed over one or more networks 530. For the sake of illustration, a wireless network 530 is shown. In other embodiments, any of wired, wireless, and/or a combination thereof can be used to facilitate communication between the entities.

The server 510 receives sequential data inputs from client devices 520. The server 510 may control one of the systems 541 and/or 542 based on a prediction generated from a disentanglement model stored on the server 510. In an embodiment, the sequential data inputs can relate to time series data that, in turn, relates to the controlled systems 541 and/or 542 such as, for example, but not limited to sensor data. Control can relate to turning an impending failing element off, swapping out a failed component for another operating component, switching to a secure network, and so forth.

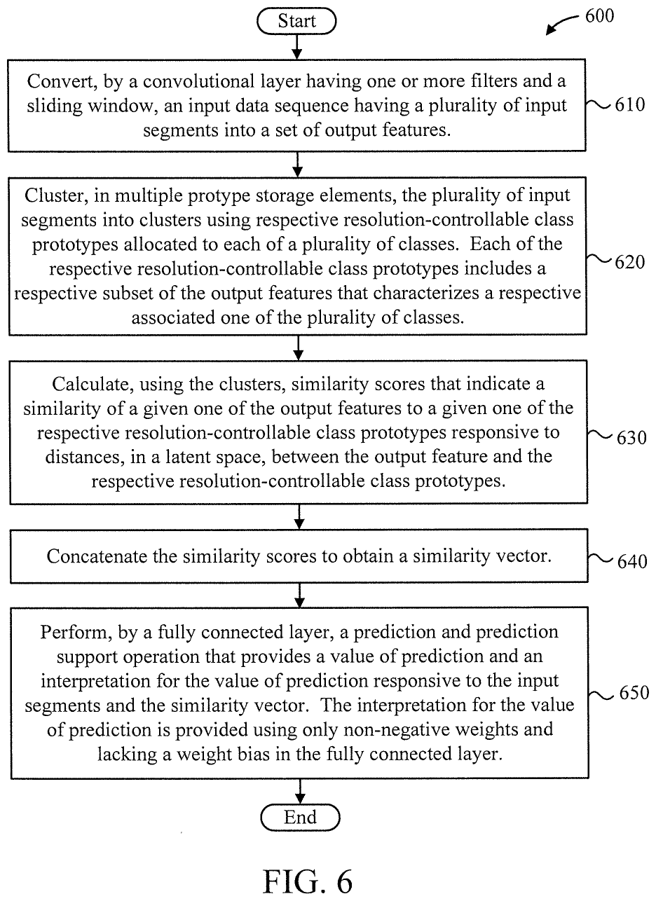

FIG. 6 is a flow diagram showing an exemplary method 600 for interpreting a convolutional sequence model by learning local and resolution-controllable prototypes, in accordance with an embodiment of the present invention.

At block 610, convert, by a convolutional layer having one or more filters and a sliding window, an input data sequence having a plurality of input segments into a set of output features.

At block 620, cluster, in multiple protype storage elements, the plurality of input segments into clusters using respective resolution-controllable class prototypes allocated to each of a plurality of classes. Each of the respective resolution-controllable class prototypes includes a respective subset of the output features that characterizes a respective associated one of the plurality of classes.

At block 630, calculate, using the clusters, similarity scores that indicate a similarity of a given one of the output features to a given one of the respective resolution-controllable class prototypes responsive to distances, in a latent space, between the output feature and the respective resolution-controllable class prototypes.

At block 640, concatenate the similarity scores to obtain a similarity vector.

At block 650, perform, by a fully connected layer, a prediction and prediction support operation that provides a value of prediction and an interpretation for the value of prediction responsive to the input segments and the similarity vector. The interpretation for the value of prediction is provided using only non-negative weights and lacking a weight bias in the fully connected layer.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for interpreting a convolutional sequence model, the method comprising:
converting, by a convolutional layer having one or more filters and a sliding window, an input data sequence having a plurality of input segments into a set of output features;
clustering, in multiple protype storage elements, the plurality of input segments into clusters using respective resolution-controllable class prototypes allocated to each of a plurality of classes, each of the respective resolution-controllable class prototypes including a respective subset of the output features that characterizes a respective associated one of the plurality of classes;
calculating, using the clusters, similarity scores that indicate a similarity of a given one of the output features to a given one of the respective resolution-controllable class prototypes responsive to distances, in a latent space, between the output feature and the respective resolution-controllable class prototypes;
concatenating the similarity scores to obtain a similarity vector; and
performing, by a fully connected layer, a prediction and prediction support operation that provides a value of prediction and an interpretation for the value of prediction responsive to the input segments and the similarity vector, wherein the interpretation for the value of prediction is provided using only non-negative weights and lacking a weight bias in the fully connected layer.

2. The computer-implemented method of claim 1, wherein the set of output features is represented by a non-linear function plus a bias term.

3. The computer-implemented method of claim 1, wherein each of the class prototypes collectively form a class prototype vector that is a latent representation of a prototypical segment learned through gradient descent.

4. The computer-implemented method of claim 1, wherein each of the respective resolution-controllable class prototypes has a selectable resolution corresponding to an associated one of the one or more filters.

5. The computer-implemented method of claim 1, wherein a dimensionality of each of the respective resolution-controllable class prototypes is equal to a dimensionality of each of the output features allocated thereto.

6. The computer-implemented method of claim 1, wherein a number of the multiple protype storage elements is equal to a number of the one or more filters in the convolutional layer.

7. The computer-implemented method of claim 1, wherein the one or more filters comprise multiple filters having different size lengths configured to selectively address different resolutions of the plurality of input segments corresponding to different levels of granularity.

8. The computer-implemented method of claim 1, wherein the similarity scores range from 0 to 1, wherein a 0 indicates that the given one of the output features is different from the given one of the respective resolution-controllable class prototypes, and a 1 indicates that the given one of the output features is identical to the given one of the respective resolution-controllable class prototypes.

9. The computer-implemented method of claim 1, further comprising performing a max pooling operation on the similarity scores to obtain a similarity vector.

10. The computer-implemented method of claim 9, further comprising evaluating the similarity vector to determine a closeness of the given one of the output features to the respective resolution-controllable class prototypes.

11. The computer-implemented method of claim 1, further comprising applying a softmax operation to an output of the fully connected layer to obtain the value of prediction and the interpretation for the value of prediction.

12. The computer-implemented method of claim 1, further comprising pushing together the given one of the plurality of segments to corresponding ones of the respective resolution-controllable class prototypes under a constraint that pushing is only to occur toward the corresponding ones of the respective-controllable class prototypes having a same class and further under at least one distance-based loss function.

13. The computer-implemented method of claim 1, wherein said performing step is performed to solve an optimization problem having an accuracy component and an interpretability component.

14. The computer-implemented method of claim 13, wherein said calculating step comprises using a diversity regularization that penalizes small distances between the respective resolution-controllable class prototypes below a diversity regularization threshold distance.

15. A computer program product for interpreting a convolutional sequence model, the computer program product comprising a non-transitory computer readable storage medium having program instructions embodied therewith, the program instructions executable by a computer to cause the computer to perform a method comprising:
converting, by a convolutional layer having one or more filters and a sliding window, an input data sequence having a plurality of input segments into a set of output features;
clustering, in multiple protype storage elements, the plurality of input segments into clusters using respective resolution-controllable class prototypes allocated to each of a plurality of classes, each of the respective resolution-controllable class prototypes including a respective subset of the output features that characterizes a respective associated one of the plurality of classes;
calculating, using the clusters, similarity scores that indicate a similarity of a given one of the output features to a given one of the respective resolution-controllable class prototypes responsive to distances, in a latent space, between the output feature and the respective resolution-controllable class prototypes;
concatenating the similarity scores to obtain a similarity vector; and
performing, by a fully connected layer, a prediction and prediction support operation that provides a value of prediction and an interpretation for the value of prediction responsive to the input segments and the similarity vector, wherein the interpretation for the value of prediction is provided using only non-negative weights and lacking a weight bias in the fully connected layer.

16. The computer program product of claim 15, wherein the set of output features is represented by a non-linear function plus a bias term.

17. The computer program product of claim 15, wherein each of the class prototypes collectively form a class prototype vector that is a latent representation of a prototypical segment learned through gradient descent.

18. The computer program product of claim 15, wherein each of the respective resolution-controllable class prototypes has a selectable resolution corresponding to an associated one of the one or more filters.

19. The computer program product of claim 15, wherein a dimensionality of each of the respective resolution-controllable class prototypes is equal to a dimensionality of each of the output features allocated thereto.

20. A computer processing system for interpreting a convolutional sequence model, the system comprising:
a memory device for storing program code therein; and
a processor device operatively coupled to the memory device for running the program code to
convert, using a convolutional layer having one or more filters and a sliding window, an input data sequence having a plurality of input segments into a set of output features;
cluster, in multiple protype storage elements in the memory device, the plurality of input segments into clusters using respective resolution-controllable class prototypes allocated to each of a plurality of classes, each of the respective resolution-controllable class prototypes including a respective subset of the output features that characterizes a respective associated one of the plurality of classes;
calculate, using the clusters, similarity scores that indicate a similarity of a given one of the output features to a given one of the respective resolution-controllable class prototypes responsive to distances, in a latent space, between the output feature and the respective resolution-controllable class prototypes;
concatenate the similarity scores to obtain a similarity vector; and
perform, by a fully connected layer, a prediction and prediction support operation that provides a value of prediction and an interpretation for the value of prediction responsive to the input segments and the similarity vector, wherein the interpretation for the value of prediction is provided using only non-negative weights and lacking a weight bias in the fully connected layer.
